(19) United States
(12) Patent Application Publication
(10) Pub. No.: US 2001/0037303 A1
(43) Pub. Date: Nov. 1, 2001

(54) Method and system for selectively recording content relating to an audio/visual presentation

(76) Inventor: Robert Mizrahi, New York, NY (US)

Correspondence Address: Brown Raysman Millstein Felder & Steiner LLP, 900 Third Avenue, New York, NY, 10022-4728, US

(21) Appl. No.: 09/799,885

(22) Filed: Mar. 5, 2001

Related U.S. Application Data
(60) Provisional application No. 60/187,242, filed on Mar. 3, 2000.

(51) Int. Cl. G06F 17/60

(52) U.S. Cl. 705/52

(57) ABSTRACT

A method system and apparatus of the patron selection, retrieval and recording of diverse content of an audiovisual presentation in a pre-determined venue. The method includes the steps of providing a patron with an access key identifying the patron to a network linking the audio visual presentation and an interactive patron station, preferably the patron's interactive seat, and including a network connection allowing the patron to interact through the patron station with the presentation and recording apparatus whereby the patron interfaces with the interactive patron station to select and retrieve predetermined audio, video and or audio visual content of the presentation for recording, and recording the selected content, thereby providing the patron with tailored recording of patron selected content for viewing and or editing. The patron in effect becomes his or her own DJ, VJ or director-producer.

Applicant hereby claims the benefit of provisional application serial No. 60/187,242, filed Mar. 3,2000, titled “MEANS AND METHOD FOR SELECTIVELY RECORDING PORTIONS OF AUDIO/VISUAL MATERIAL,” which application is hereby incorporated herein by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The present invention relates to content delivery systems and, more particularly, to methods and systems for allowing patrons to interactively select, retrieve, and record content representing portions of or relating to audiovisual presentations such as motion pictures.

The high cost of developing audiovisual content such as motion pictures is well known, as is the need for developers to reap the highest possible rewards on such content. As a result, content developers seek many avenues for distribution of their content. For example, movie studios seek varied revenue in the forms of box office receipts, sales and rentals of videos and DVDs, sales of motion picture soundtracks, and reuse of portions of movies such as in video games, merchandising, and television commercials.

One effective way to maximize these various revenues is by informing patrons of the availability of these various items of content in conjunction with the viewing of the motion picture itself, such as in a trailer or advertisement before presentation of the movie in a theater or on a videocassette. Similarly, some items such as soundtracks or merchandise are made available in lobbies of live theater or concerts to entice patrons who have just viewed a presentation to make impulse purchases.

However, the success of these marketing efforts is limited by the fact that patrons who are watching or have watched a movie or other audiovisual presentation often like limited portions of a presentation but not necessarily the entire set of content in the presentation. For example, patrons may like one or two songs played during a movie but not the entire soundtrack. Patrons may further have interest in receiving extra, ancillary information or content about the artists who recorded these songs, but not necessarily about other aspects of the movie. Similarly, patrons may have liked only certain scenes within a movie, perhaps those involving exciting occurrences, their favorite stars, or interesting special effects. Thus, many patrons may be more willing to purchase, particularly on an impulse, these limited portions of the content and ancillary information about these portions but would not be willing to spend additional money to purchase an entire set of content.

Several patents discuss vending systems in which a consumer may selectively choose various recorded materials for purchase. Examples include: U.S. Pat. No. 3,947,882 issued Mar. 30, 1976 to Lightener, and titled VENDING SYSTEM FOR REMOTELY ACCESSIBLE STORED INFORMATION; U.S. Pat. No. 5,845,262 issued Dec. 1, 1998 to Nozue et al., and titled ELECTRONIC PRESS INFORMATION DISPATCHING SYSTEM; U.S. Pat. No. 5,900,608 issued May 4, 1999 to lida, and titled METHOD OF PURCHASING PERSONAL RECORDING MEDIA, SYSTEM FOR PURCHASING PERSONAL RECORDING MEDIA, AND MEDIA RECORDED WITH PURCHASING PROGRAM; and U.S. Pat. No. 4,703,465 issued Oct. 27, 1987 to Parker, and titled METHOD AND APPARATUS FOR PRODUCING AN AUDIO MAGNETIC TAPE RECORDING FROM A PRESELECTED MUSIC LIBRARY. However, these patents fail to provide solutions which allow for selective impulse purchases.

Similarly, U.S. Pat. No. 5,539,635, issued Jul. 23, 1996, to Larson, Jr., and titled RADIO STATION PROGRAM IDENTIFIED AND DISTRIBUTION SYSTEM, discloses a radio station program identifier and distribution system. In accordance with the system, a radio station broadcasts in its typical manner. The system then creates an entry in a database identifying the program, the time, and the date when the programs are transmitted by a participating broadcaster. When customers hear a song or program in which they are interested, they may order a copy by contacting the system and indicating the time, date, and broadcaster of the programs(s) of interest.

As another example, U.S. Pat. No. 5,819,049 issued Oct. 6, 1998 to Rietmann, and titled MULTI-MEDIA RECORDING SYSTEM AND METHOD, discloses a system that includes a multi-media formatting distribution center that inputs a signal representative of an audio/visual medium to a first computer, transfers the signal to a second computer to record the signal, and plays or records the recorded audio/visual signal.

However, none of these patents describes a system or method which takes full and proper advantage of the presence of patrons at venues such as movie theaters or airplanes at which they are viewing movies or other presentations and, depending on their level of satisfaction, would be likely to make impulse purchases of selected portions of the content in the movies. There is thus a need for improved systems and methods which provide this functionality.

The following additional patents provide further background and technical information relating to the subject matter of the present invention:

U.S. Pat. No. 5,730,283, issued Mar. 24, 1998, to Lax, and titled PACKAGE AND STORAGE UNIT FOR DIGITAL INFORMATION STORAGE MEDIA, discloses a tray for receiving and storing compact disks of the type that may be employed to store compact discs used in the present invention.

U.S. Pat. No. 5,729,516, issued Mar. 17, 1998, to Tozaki et al., and titled INFORMATION RECORDING MEDIUM, APPARATUS FOR RECORDING THE SAME AND APPARATUS FOR REPRODUCING THE SAME, discloses a system for flagging items recorded in a recording medium. The flagging indicates, for example, whether a particular item is wholly copy prohibited, partially copy prohibited, or wholly copy permitted. Further disclosed is an apparatus for reproducing copy permitted items.

U.S. Pat. No. 5,841,512, issued Nov. 24, 1998, to Goodhill, and titled METHODS OF PREVIEWING AND EDITING MOTION PICTURES, discloses a system in which motion picture images are transferred to a high definition video storage medium and digital nonlinear motion picture equipment is used to generate an edit decision list. The digital nonlinear equipment is further used to generate a negative cutting list based on audience reaction to a preview of the initial edit.

U.S. Pat. No. 5,872,615, issued Feb. 16, 1999, to Harris Jr., and titled MOTION PICTURE PRESENTATION SYSTEM, discloses a microprocessor based system for controlling variable, such as light, sound, and audio associated with the presentation of a motion picture film.

U.S. Pat. No. 5,924,013, issued Jul. 13, 1999, to Guido et al., and titled METHOD AND APPARATUS FOR TRANSMITTING MOTION PICTURE CINEMATIC INFORMATION FOR VIEWING IN MOVIE THEATERS AND ORDERING METHOD THEREFORE, discloses a method and apparatus for transmitting motion picture information. The motion picture information is transmitted via RF signals from a central site to a movie theater. The data received at the movie theater is converted from digital format for projection on a screen.

All of the above identified patents are hereby incorporated herein by reference.

### SUMMARY OF THE INVENTION

Accordingly, it is an object of the present invention to solve the problems described above relating to content delivery systems.

It is another object of the present invention to provide means for a patron to select and retrieve desired content of and related to an audiovisual presentation.

It is another object of the invention for a patron to custom record selected audio and video materials, and in effect be ones' own DJ, VJ or producer-director.

It is a further object of the invention to provide such means and method that allow the patron to record patron selected predetermined content not necessarily in but related to the presentation.

It is another object of the invention to provide such means and method as aforesaid that further provide and permit the automatic crediting of copyright royalties to the appropriate respective copyright owner.

It is yet a further object of the invention to provide such means and method as aforesaid that further permit a patron to be automatically charged a fee commensurate with the patron selected recorded content.

It is yet an additional object of the invention to provide such means as aforesaid that further includes a patron seat in which are disposed operational elements for the said selection, retrieval and recording of the content.

It is yet another object of the invention to provide such means and method that are economical and easily implemented by one skilled in the art.

The above and other objects are achieved by methods and systems for allowing a patron such as a movie goer to selectively record content relating to an audiovisual presentation. The presentation is of the type presented at a predetermined venue and at a first time period not within the patron's control. Examples of such presentations include movies presented at specific movie theaters at scheduled times, movies shown on airplanes during travel at times selected by airline staff, or movies or other content shown on monitors in airport terminals, taverns, or similar venues. The method involves presenting to the patron a number of selections representing content relating to the presentation during a second time period linked to the first time period, and allowing the patron to select one or more of the selections. Copies of the selected portions are then delivered to the patron.

The selections may be shown to the patron through any number of possible devices, such as a device affixed to or detachably attached to a seat in which the patron sits during the presentation, or a portable device connectable with a local or remotely located system which transmits the selections. In some embodiments, the patron may access a web site over a web enabled portable device such as a cellular telephone, airphone, or palm pilot, and would identify the venue and time. The web site would transmit the possible selections based on the movie being shown at the identified venue and time, as determined from a stored schedule of movies. The patron's desired selections would then be transmitted back to the local or remote system. The same or another system may then deliver the content copies selected by the patron either at the time of the request to a recordable medium located at the patron's seat or afterwards to a computerized device designated by the patron. For example, the patron may supply an email address to the system, and files containing the selected content are transmitted as attachments to an email sent to the specified address.

In accordance with the invention, the content selections are available to the patron during the second time period which is linked to the first time period of the presentation. The first time period may be the scheduled time period for the presentation, such as may be stored as just described, or the actual time in which the movie is presented, such as on an airplane or in an airport or tavern setting. The second time period may be contemporaneous with the first, meaning that patrons would be offered selections during presentation of the movie, or may be for some limited time following the first, such as ten or fifteen minutes following the end of the movie or longer. Alternatively, patrons may be given the opportunity to indicate interest in some portion of a movie during its showing, such as by pressing a single button at a given time, and then following the movie be given the opportunity to specifically select the content selection they desired to obtain.

As a further alternative, patrons register with the system during the second time period to receive the list of content selections, based on, for example, the fact that they were present during the movie or other presentation. The patrons access the system later, such as over the Internet from a home personal computer, to download the menu of content selections and select desired content to be received.

Further in accordance with embodiments of the invention, patrons would pay for the content selected, such as through a credit card entered at a reader located on the patron's seat or by secure transmission of credit card information to a remotely located delivery system as described above. The delivery system may further account for content purchased or otherwise delivered so that royalties may be paid to copyright holders of the delivered content.

The content selections available for purchase may include portions of the presentation, such as clips, songs, dialog, graphics in special effects, etc., as well as ancillary content relating to the presentation, such as director's bios, location footage, behind-the-scenes footage, alternate cuts, music videos of songs in the movie, etc.

The present invention also achieves the above objects, among others, by providing, in described embodiments, a method, system and apparatus for selecting and retrieving audio/visual content to a patron or like user of an audio/visual presentation in a pre-determined venue. The method of some embodiments includes providing a patron with an access means identifying the patron to a network and linking the presentation and an interactive patron seat or station. The method and system also includes a network connection allowing the patron to interact at the patron station with the presentation and recording means to select presentation content for recording either by the recording means itself or on other local or remotely located memory devices. The recording means, in one embodiment, is removably operably disposed in the access means. The patron may, in another embodiment, be provided with a copy of the selected-recorded content at the venue.

The patron selecting and recording of the patron's own desired specific content or material allows for limitless custom-recorded audio/video “packages.” The patron becomes essentially the patron's own DJ or VJ, sound or video editor, or producer-director, thus enabling the patron to create the patron's own presentation experience, since the patron is now interacting with the presentation, not just passively watching it. Each presentation experience becomes uniquely personal to that individual patron.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram showing a system at a predetermined venue for delivering content in accordance with one embodiment of the present invention;

FIG. 2 is a flow chart showing a process for delivering content using the system of FIG. 1 in accordance with one embodiment of the present invention;

FIG. 3 is a block diagram showing an alternative system for delivering content through a distribution system located remotely from the predetermined venue in accordance with one embodiment of the present invention;

FIGS. 4A-4B contain a flow chart showing a process for delivering content using the distribution system of FIG. 3 in accordance with one embodiment of the present invention;

FIG. 5 is a block diagram of an alternative system for delivering content including a patron station with an interactive arm rest and portable access device in accordance with one embodiment of the present invention;

FIG. 6 is a schematic, top plan view of an exemplary interactive arm rest for use in the system of FIG. 5;

FIG. 7 is an exemplary screen display of a menu used with the present invention;

FIGS. 8A and 8B are fragmentary isometric views and FIG. 8C is a top plan view of the portable access device of the present invention for use in the system of FIG. 5;

FIG. 9 is a fragmentary isometric view of a detail of the interaction of the portable access device and an armrest;

FIGS. 10A and 10B are top plan views, in cross-section, of the portable access device being inserted in an armrest;

FIGS. 11A, 11B, and 11C are isometric views of an alternative embodiment of this portable access device;

FIGS. 12A and 12B are isometric views of a further embodiment of this portable access device;

FIG. 13 is a fragmentary isometric view of an alternative method of inserting this portable access device into an armrest; and

FIG. 14 is a top plan view of a menu according to this example of the present invention inserted in a plastic sleeve.

### DETAILED DESCRIPTION OF THE PREFERRED EMBODIMENTS

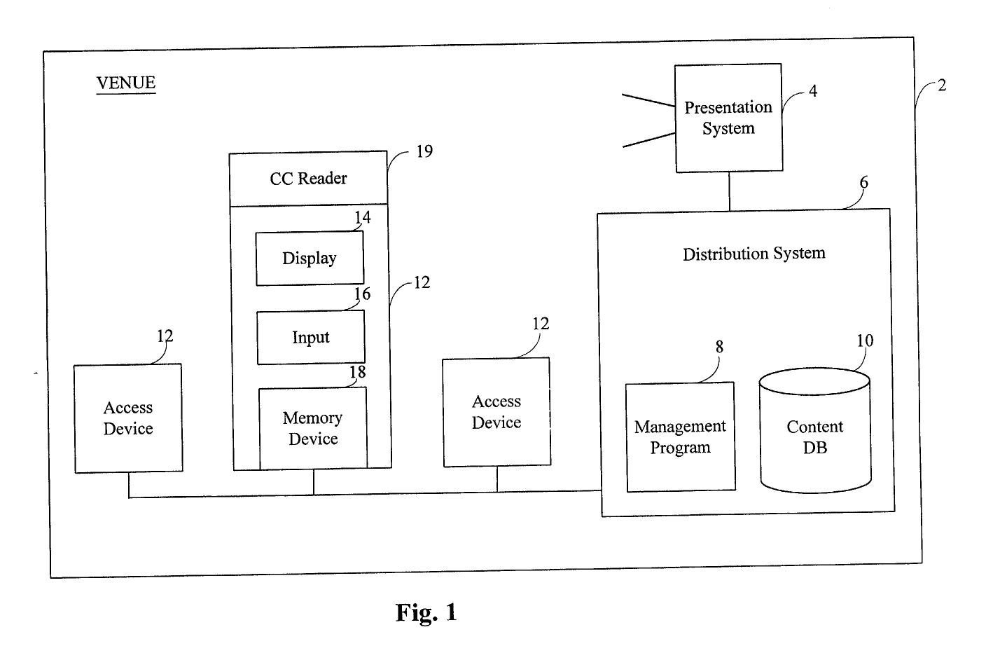

Preferred embodiments are now described in detail with reference to the drawings in the Figures. In accordance with the invention, specific items of content forming part of or otherwise relating to an audiovisual presentation is made available for delivery to patrons of the presentation. As described in greater detail below, the content choices are presented as a menu to the patron during or shortly after the presentation, or otherwise by virtue of the patron's association with the presentation, and the patron may receive selected choices for recording on a device during the presentation or may receive the choices later through delivery over a network. Several alternative systems for supporting this inventive arrangement are shown in FIGS. 1, 3, and 5.

In FIG. 1, a predetermined venue 2 at which a presentation is available contains all elements of the system needed to support the content delivery. Exemplary venues 2 include movie theaters, airplanes, airport terminals, bars, amusement parks, schools, or other similar locations at which presentations are shown by third parties to patrons and patrons do not control the time and/or course of the presentation. The venue 2 includes a presentation system 4, such as a movie projection system, cable or satellite receiver, or video cassette or DVD player. The venue 2 also contains a computerized distribution system 6 which includes a management program 8 and a content database 10. The distribution system 6 is linked to the presentation system 4 to support the distribution of content relating to a current presentation or current point of time within a presentation. The management program 8 offers content choices to patrons through patron access devices 12, manages requests for content from patrons, manages delivery of the content to the access devices 12, and logs content delivered for use in accounting for royalties, in accordance with processes described further below.

Access devices 12 used by patrons are situated at stations from which patrons view the presentation, such as movie theater or airplane seats. The access devices 12 may be permanently affixed to the patron stations or may be attachable to such stations and rented or lent to patrons for use during the presentation. For example, such devices may be made available in movie theater lobbies or by airplane personnel at the request of particular patrons. As shown for one such device 12 in FIG. 1, an access device includes a display 14, an input device 16, and a detachable memory device 18. Exemplary access devices 12 and detachable memories 18 are shown and described in greater detail below with reference to FIGS. 6-14. Access devices may also include a controller for processing input and output, but need not and may be “dumb” terminal devices if all such processing is all performed by the distribution system 6.

Access devices 12 may also contain credit card readers 19 for receiving payment information from patrons in the form of credit, debit, or membership cards. Alternatively, patrons may supply this information when obtaining an access device 12 for use during the presentation.

The content stored in content database 10 includes content items of audio, visual, audiovisual, textual, graphic, or other data types. The content items are portions of the presentation, such as clips from the movie, songs from the movie, text of dialog, or computer graphics used in special effects, as well as additional, ancillary content relating to but not incorporated in the presentation. Ancillary content includes director's or actor's biographies, location footage, behind-the-scenes footage, alternate cuts, music videos of songs in the movie, video games, etc. The content may be in any conventional or desired format, including MPEG, JPEG, HTML, MP3, WAV, Atrac 3, etc. In accordance with the invention, patrons are given a specific set of choices of content items from the content database 10, with the choices being shown as a menu on the display 14.

Thus, the system described herein allows patrons to create unique compilations of content from or relating to a movie or other presentation. For example, patrons can receive particular songs, groups of songs, or an entire soundtrack arranged in any desired order. Similarly, patrons can receive parts of a film containing, for example, incredible special effects, riveting dialogue, a particularly memorable love or action scene, a still, or other additional material.

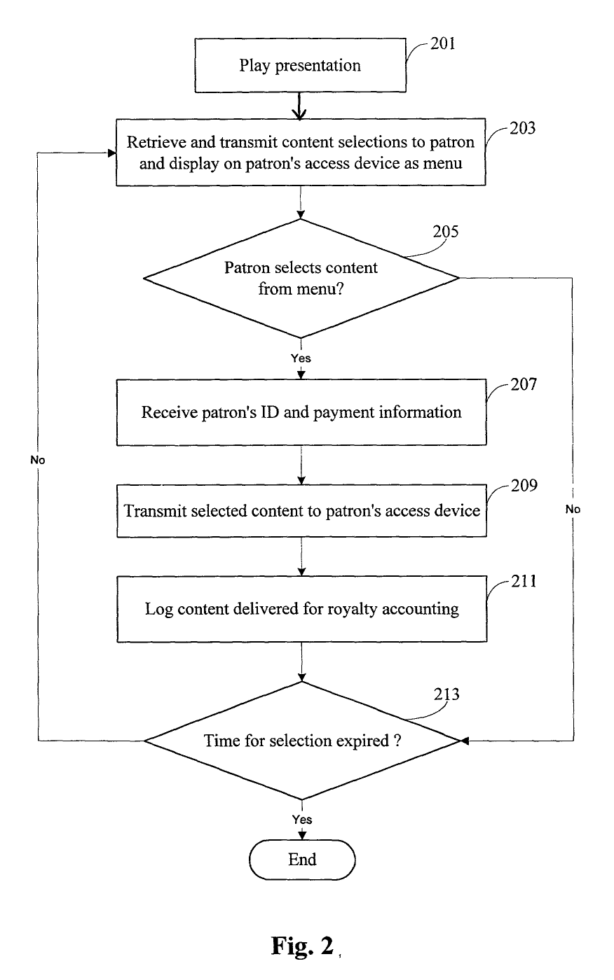

Referring to FIG. 2, a process for delivering content in the venue 2 of FIG. 1 involves, during or shortly after playing of the presentation, step 201, the management program 8 retrieves content selections relating to the presentation from the content database 10, and transmits these content selections to the patron's access device 12, and these selections are displayed on the device as a menu, step 203. The content selections sent may be predetermined and fixed, or may be retrieved based on various conditions including the current point in the presentation or demographics or other information obtained about the patron. For example, the content selections may change during the course of the presentation to relate to current activity in the presentation.

If the patron makes a selection, step 205, the program retrieves the patron's ID and payment information, step 207, and retrieves the selected content from the content database and transmits the content to the patron's access device, step 209. The management program further logs the content delivered to the patron in a file, step 211, so that an accounting may be made to the copyright holder for sale of the content. If time for the patron to make selections from the menu has expired, step 213, either because the time for these particular selections has passed in the presentation or because the presentation and any extra time allotted for purchasing content has expired, the program no longer shows the patron these particular choices and no longer accepts selections. If the time has not expired, the management program retrieves any additional selections which may be available and/or continues to display the existing choices and to accept patron selections. Content recorded or copied onto the patron's detachable memory device may be viewed or listened to by the patron on a suitable player in his home or elsewhere.

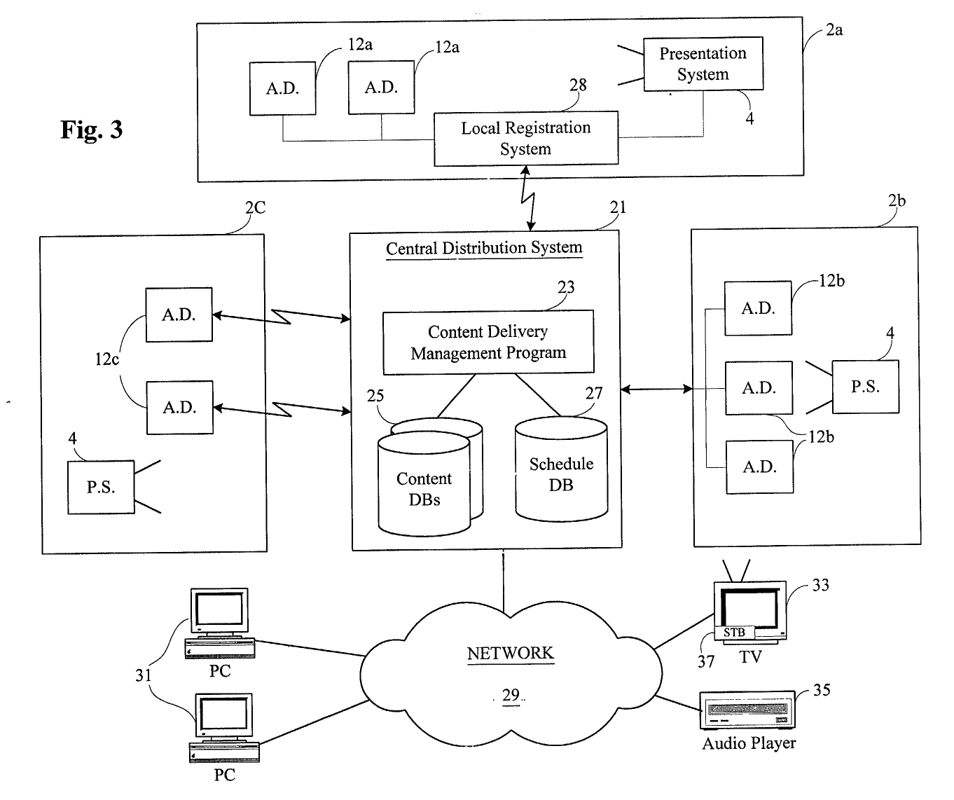

FIG. 3 shows alternative embodiments of the content delivery system of the present invention including venues 2a, 2b, and 2c having different configurations, and a computerized central distribution system 21 located remotely from (not within the physical structures of) the venues. Each venue includes a presentation system 4 as well as access devices 12a, 12b, and 12c. The access devices receive content selections from the central distribution system 21 and transmit patron selections to the central distribution system 21. The central distribution system then transmits the selected and purchased content back to the access devices as described above and/or to addresses or devices designated by patrons and accessible over a network 29 such as the Internet. The devices include personal computers 31, television receivers 33 connected to Internet-ready set top boxes 37 and storage devices, and audio players 35 such as MP3 players. Examples of MP3 players include WinAmp software for PCs or MACs, Realplayer software, and hardware devices such as Audiovox or RCA/Thomson Lyra.

The central distribution system, which may consist of one or more computer servers, has residing and running thereon a content delivery management program 23, as well as memory devices storing content databases 25 and a schedule database 27. The content databases contains content items available for delivery, similar to content database 10 in FIG. 1. The schedule database 27 contains a listing of the presentations available at various venues including venues 2a, 2b, and 2c, and the times of their showings. In some embodiments, the central distribution system 21 is a web server.

In accordance with the invention, the three exemplary venues 2a, 2b, and 2c illustrate three alternative ways in which access devices present at the showing of a presentation can connect and interact with the content delivery program to receive content item selections and purchase the content. In venue 2a, a local registration system 28 connects the access devices 12a with the central distribution system 21 by conveying messages back and forth. The local registration system 28 may also handle discrete tasks in the process, such as accepting payment information and confirming to the distribution system that payment has been accepted. One skilled in the art will recognize the advantages of providing additional functions to be performed by the local registration system 28.

In venue 2b, access devices 12b are connected in permanent fashion with the central distribution system 21 by wired or wireless technology. All the processing needed to support content selection and delivery as described herein is performed at the central system 21, and the access devices 12b are each uniquely recognized and addressable by the central distribution system by virtue of unique identifiers and/or addresses.

Unlike the other venues, venue 2c has no permanent wiring or systems installed therein. Rather, access devices 12c are provided to communicate directly with the central distribution system 21. The access devices 12a, 12b, and 12c may of the type described above and in greater detail below, including slots for detachable memory cards. However, since the content is transmitted to other storage devices, the access devices need not contain that feature, and may rather be simplified terminal devices. Similarly, the access devices in these venues, particularly in venue 12c, may be portable communication devices such as cell phones or palm pilots, which communicate directly with the central distribution system 21.

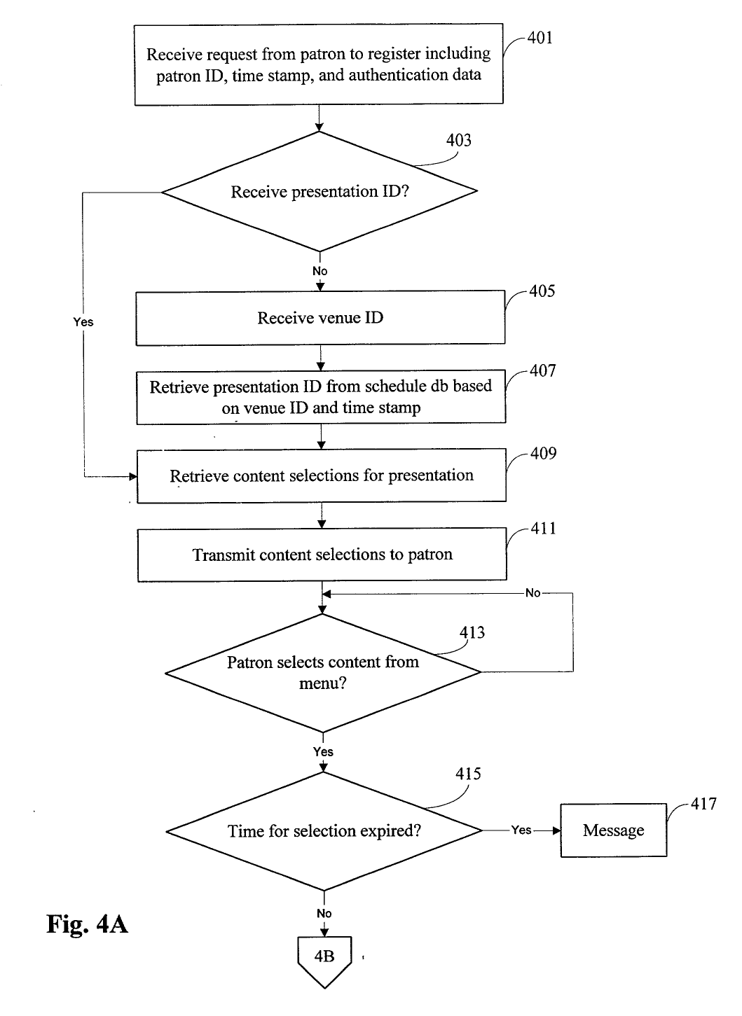

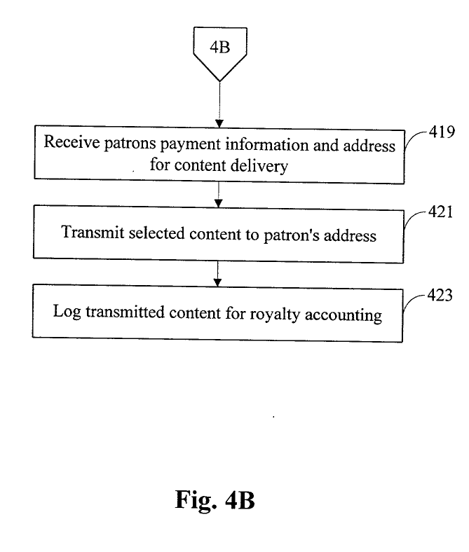

A process performed by the central distribution system 21, particularly the content delivery management program, is shown in FIGS. 4A-4B. The program receives a request from a patron situation at any venue to register, step 401. This request should include a patron ID, time stamp of the request, and authentication data used to authenticate that the patron is indeed present at a venue showing a presentation. For access devices which are installed or otherwise remain within the venue, the authentication data may be embedded in the access device. Alternatively, patrons may be provided with a unique code when present at the venue for use as the authentication data.

If the program receives an identifier for the presentation attended by the patron, step 403, it retrieves the content selections for the given presentation, step 409. The presentation ID may be sent, for example, by the local registration system, as part of the authentication data, or by the patron himself. The presentation ID could be the name of the movie or some other unique code identifying the movie. If no presentation data is received, the program must receive a venue identifier, step 405, which it uses along with the time stamp to retrieve the identifier for the presentation from the schedule database, step 407. For example, the schedule database lists what movies are playing in which theaters at which times, and the management program may determine the movie playing based on the theater and time of show. For movie theaters having multiple screens, the venue ID would include the screen number as well as the theater name and/or location. The presentation ID is used to retrieve the content selections, step 409.

The content selections are transmitted to the requesting patron's access device, step 411, using the communication protocols appropriate to the system being used, such as IP/TCP, WAP, HTTP, etc. The content selections are presented as a menu on the patron's access device, and the patron may select one or more items from the menu, step 413. If the time in which the patron is allowed to make selections has expired, step 415, the program sends a message to this effect to the patrons, step 417. As explained above, the time for selections may be set as during the presentation or for a fixed time thereafter. Alternatively, the patron may not be so limited in time, but may be able to make selections at any time thereafter by virtue of having registered with the central distribution system while at the venue.

If the patron makes one or more content selections, the program receives the patron's payment information and an address for delivery of the content, step 419. The payment information may be a credit or debit card number or Internet virtual cash account number, as known to those of skill in the art. The address may be an email address, URL, FTP site, etc. These items of information may alternatively have been provided when the patron initially registered. The content delivery management program retrieves the selected and purchased content and transmits is to the patron's address, step 421. It also logs the transmitted content for copyright royalty accounting, step 423.

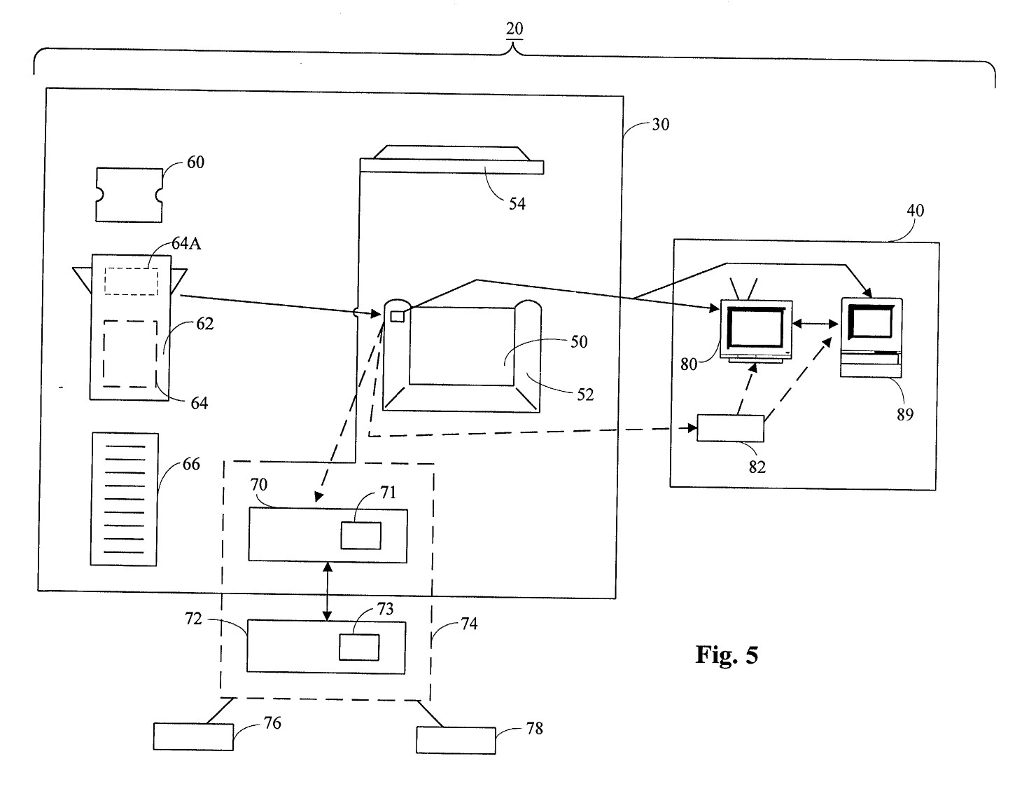

FIG. 5 illustrates a further alternative system according to the present invention, generally indicated by the reference numeral 20. System 20 includes a first or pre-determined venue 30 which may be, by way of example and without limitation, a theater, a bus, a train, an aircraft, an airport terminal, a bar or lounge or like presentation display venue. System 20 also includes a second venue 40 which may be, and usually is, for example, a portion of the residence of a user (not shown) of the system.

System 20 provides patrons of an audio/visual presentation, for example, a movie, with the opportunity to record selected content from the presentation for later viewing and/or listening in the privacy of a second venue 40, for example, their own home. System 20 is generally implemented by providing a patron with a portable access device 62 (for example, an access key) identifying the patron to network 74. The distribution network 74 links a presentation system, (for example a screen system 54) and an interactive patron seat or station 50 including a network connection allowing the patron to interact with presentation system 54 and recording means (for example, slots 400 or 420 in FIG. 6). The patron then interacts with a patron interface (for example, control arm 52) associated with interactive user seat or chair 50 to select content of and or related to the presentation for recording. The selected content is then recorded to create a copy which is provided to the patron for later viewing and/or listening and/or editing.

First venue 30 includes an interactive patron or user station and a screen system 54 for the audio/visual presentation. In accordance with a preferred embodiment of the present invention, the interactive patron or user station includes a seat 50, the seat having at least one armrest or similar structure 52. Although the disclosed preferred embodiment includes a seat 50, the interactive user station may take a variety of forms without departing from the spirit of the present invention. Screen system 54 may be a standard screen when first venue 30 is a theater or it may be a television or video screen or the like when first venue is not a theater.

Also illustrated as part of first venue 30 are a ticket 60, a portable access device 62 having disposed therein electronic circuitry 64 (the portable access device being adapted to be inserted into armrest 52) and a menu 66. Electronic circuitry 64 is provided to control the recording operation on a recording medium, e.g. a SmartMedia or Flash card 64A, disposed in access device 62, and to transmit data to and receive data from other elements, as is more fully described below. A local controller 70 in first venue 30 is operatively connected to armrest 52, while a remote controller 72 is operatively connected to the local controller 70. The local and remote controllers comprise part of a network 74.

Network 74 is linked to seat 50 and screen system 54 to provide presentation, or programming, information to both elements. In this way, seat 50 and presentation system 54 are linked such that the presentation information is provided to screen system 54 for viewing by the patron and selected presentation information is provided via menu to chair 50 for recording by the patron in the manner as further discussed below in detail.

Network 74 controls interaction between the presentation taking place on the screen system 54 and the recording of information taking place at the interactive patron seat 50. Specifically, local controller 70 stores presentation information and includes a microprocessor 71 programmed to transmit selected presentation information to the screen system 54 for viewing by the patron. The microprocessor 71 is also programmed to respond to patron requests for the recording of selected presentation information.

The patron interacts with the control armrest 52, whereby recording requests are transmitted to the local controller 70 of the network 74. The recording requests are processed by the microprocessor 71 of the local controller 70 and the requested presentation information is transmitted to the control armrest 52 for recording on the appropriate recording medium in a manner discussed below in greater detail. The presentation information may be transmitted to other locations where the actual recording takes place such as at a location remote from the control armrest 52 as is further discussed below in greater detail. Since local controller 70 controls the transmission of presentation information to the screen system 54 and the interactive user seat 50, the local controller 70 is fully capable of coordinating recording requests to provide patrons with the presentation information they request.

Network 74 also includes a remote controller 72 including a microprocessor 73 programmed to coordinate the retrieval of information required for the presentation being coordinated by the local controller 70. As such, the remote controller 72 is linked with an Internet server 76 and/or a static server 78.

Audio visual presentation information may be provided to network 74 through the use of an Internet server 76 and/or a static server 78. Internet server 76 provides distribution network 74 with presentation information from a source remote from the first venue 30, while server 78 is loaded at first venue 30 to provide presentation at only the single location. While two different sources are disclosed above for providing distribution network 74 with presentation information, those skilled in the art will readily appreciate the wide variety of content sources which may be employed within the spirit of the present invention.

Second venue 40 includes a television 80, other audio or video device, or personal computer 84 adapted to receive therein-portable access device 62 or the recording medium 64A. It is understood that where the recorded material is on e.g. a DVD or SmartMedia or Flash card, the DVD or aforementioned card may be removed from device 62 for viewing and editing. The television 80, other audio or video device, or personal computer 84 may be adapted to receive the SmartMedia or Flash card, DVD or like recording means.

FIG. 6 illustrates in more detail patron seat 50 and armrest 52. While certain elements of the invention are shown as being in armrest 52, it will be understood that those elements may be disposed elsewhere in or near seat 50 for access by a patron. Referring specifically to FIG. 6, access device 62 is inserted into a slot 400 provided therefor in armrest 52. Variations on means for inserting access device 62 in armrest 52 are discussed below. Also provided in armrest 52-is a slot 410 for insertion therein to a credit or debit card. The slot 410 includes a conventional credit or debit card reader for facilitating payment in accordance with the present invention. The armrest 52 is further provided with a slot 420 for insertion thereinto of an additional or alternate recording medium such as a CD, DVD, or tape (not shown). The slot 420 includes a recording mechanism chosen based upon the particular recording medium used in conjunction with the armrest 52.

The armrest 52 is also provided with a screen 430 on which may be presented various messages such as recording status, confirmation of the price of the current selection, and/or alerts as to when recordable material is available, for example. Where the individual is seeing a presentation for the first time, he or she might not be aware of moments in the presentation worthy of recording, In fact, the patron may not be aware that these moments are important until after the moment has passed or the presentation is over. The patron would, therefore, have missed the opportunity to record the important moment and will not be able to rewind the presentation where the presentation is being given on a large-scale system, such as a movie theater. As such, the screen 430 may be used to provide the patron with a warning that an important moment is coming up and suggest the patron activate the control buttons 440 for recording the moment.

Other such important information is a running total of charges, or a message that a minimum dollar amount is not available on the credit card, or an alert that a credit card limit is being approached may also be displayed. Also provided in the armrest 52 is a plurality of control buttons 440 with which to make recording selections and operate other functions of the system of the present invention. Credit card electronics and credit card information reporting devices are well known in the art. FIG. 7 illustrates in more detail menu 66 and some of the selections that may be provided thereon. It will be understood that control buttons 440 (FIG. 6) are employed 12 to make the selections. The patron may, by way of example, desire to retrieve and record a certain audio content e.g. a song, designated content code “011” (FIG. 7), the entire audio/visual presentation e.g. the motion picture, designated content code “017” (FIG. 7), and related material, e.g., an audio/visual presentation of the director's biography designated content code “018” (FIG. 7). The patron on viewing the motion picture in conjunction with menu 66, presses buttons 440 corresponding to “011”, “017” and “018” to retrieve and record the respective afore-described content selections.

In one basic method, a patron enters first or predetermined venue 30 such as a theater, purchases ticket 60, has, rents, or otherwise obtains a portable access device 62, and is given a menu 66 (FIGS. 5 and 6). The patron then takes seat 50 and inserts portable access device 62 into slot 400 in armrest 52. Menu 66 contains a listing of pre-determined portions or content of the audio/visual material and related audio/visual material that the patron may select to record during the presentation, the recording being done on a recording medium as is more fully described in detail below. Some or all of the menu items can be visually “tagged” during the presentation to cue the patron at the time the items are available for recording.

During the presentation, the patron may selectively indicate, or indicate and record, which portions of the presentation or other menu-selected content the patron wishes to choose. The recording can be done from seat 50 that the patron occupies, using portable access device 62 which is inserted into a recording mechanism provided in conjunction with slot 400 or other network connection located, for example, in armrest 52. Thus “interactive” armrest 52 acts as a multimedia retrieval system and allows the patron to capture sound and video while watching the presentation.

The content is in one aspect recorded on operably removable recording medium 64A in armrest 52, and particularly by portable access device 62, via static server 76 and Internet server 78 through distribution network 74. Servers 76 and 78 provide pertinent information about each particular venue 30, bringing, for example, specific songs from the presentation's soundtrack as well as specific scenes, clips, etc. to the patron through armrest 52 in first venue 30. In this way, distribution network 74 makes the selected content available to the patron by recording it onto portable access device 62, or other recording medium, while he or she views the presentation.

Once the patron “engages” with the patron station or seat 50, any interaction on the part of the patron is transmitted electronically through the network connected to network 74. The network 74 is the source of all the material or content available for recording through the use of the Internet server 76. This allows the patron, when recording, to essentially download the patron's customized selected material. The hardware containing this server can be located “on site”.

The Internet server 76 can provide at least two functions:

First, the Internet server 76 can contain essential information about each participating theater, or other first or pre-determined venue 30, in the total network and will run software that can, for example, record all “hits” made from the patron's seat, how often the patron has visited the theater or other first venue, what the patron has purchased before, etc., and a complete instant accounting and crediting of all copyrighted monies due and to whom for audio, visual, and story copyright royalties. In other words, complete patron, theater, copyright and media databases can be generated and maintained for viewer survey and analysis, and for financial and accounting purposes.

Second, the Internet server can be the source for recordation of other menu-selected predetermined materials in addition to those selected from the present audio/visual presentation. For example, such other menu-selected predetermined materials can include: the music video of a song in addition to the presentation's specific rendition, interviews with, and biographies of actors, producers, and directors, clips from presentations with related subject matter, clips from other presentations starring a particular actor, the songs from a presentation's musical artist, film dialogue (either text or audio), film trailers, and/or upcoming presentations. The present system permits the patron to be his or her own director-producer.

Portable access device 62 can encode data that specifically identifies its user and user profile information such as name, address, and Social Security number, any of which or any combination thereof can be utilized as membership or access data. This or other such user-specific information can be linked to a membership premium card for purchasing merchandise, particular including merchandise related to the audio/visual presentation. Once the patron engages portable access device into armrest 52, personalized items from the user profile can also appear as graphics or as part of the recorded content. The portable access device 62 of the present invention may employ technology for recording and playback which is similar to the detachable faceplate described in above referenced U.S. Pat. No. 5,819,049 to Rietmann, which has been incorporated by reference herein.

In addition, a hardwire/server could also run in the lobby of first venue 30, for example. Every seat 50 could have a specific encoded identifying number to wherever the patron sits, the “lobby” knows who is buying what.

Once the presentation is over, the patron obtains either the compiled-recorded materials or a list of indicated data directly from the retrieved portable access device 62. If portable access device 62 includes only a list of the indicated data, the patron will also receive a second recording medium (for example, a CD or DVD) upon which the information is recorded for use by the patron. The list on portable access device 62 will merely function as an indicator of the selected content purchased by the patron. The second recording medium may be recorded in slot 420 as previously discussed. It is also contemplated that the second recording medium may be created or recorded at a location remote from the user seat 50. For example, the second recording medium may be recorded in a designated recording room or area for pick up by the patron after viewing the presentation. Alternatively, the user in selecting the desired content may order the CD or DVD recording to be delivered to his or her credit card mailing address.

In the second basic step of the method, the patron moves to second venue 40 and couples the recording device or medium e.g. CD or DVD as afore discussed to a television 80 for viewing of the recorded materials or to a personal computer 84 for listening, viewing, downloading, or further editing of the materials. Since the materials are recorded as digital information, they are easily re-editable. Once the patron links the access device 62, or recorded medium 64A to computer 84, this data can be completely rearranged, using the personal computer, in any order the patron prefers, and/or back onto the recording device/medium itself. Data can be transferred to computer 84, all, or in part. Unwanted songs, clips, etc. can simply be recorded over when the patron returns to the theater, if so desired.

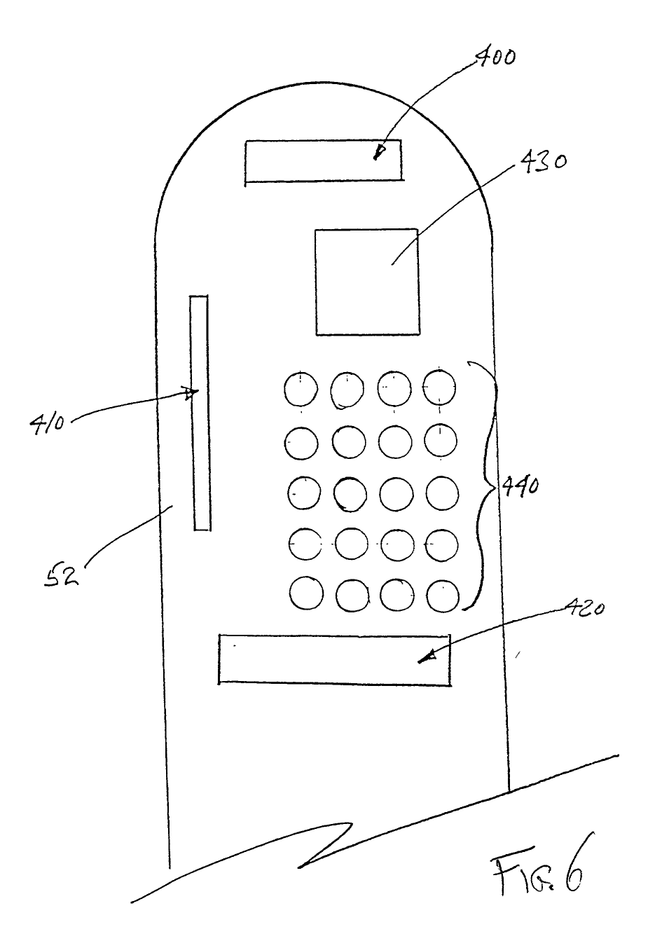

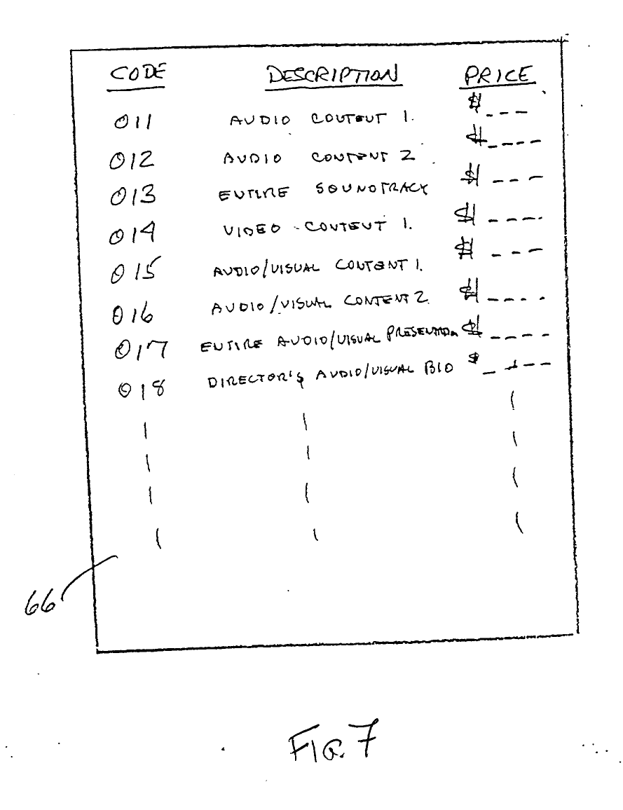

If portable access device 62 serves or can also double as a wireless transmitter, as discussed above, the patron will be capable of transmitting the recorded data directly to personal computer 84 or other wireless retrieval mechanism in a downloadable fashion. FIGS. 8A-8C illustrate the use of portable access device 62 and its insertion into armrest 52. Portable access device 62 includes a body portion 100 and two outwardly biased flipper electrical contacts 102 and 104 (FIG. 8A) disposed on either side of the body portion. Portable access device 62 is configured to be inserted in the end of armrest 52 into slot 400, and particularly, a cavity 110 defined therein, as is indicated by the arrows on FIG. 8A and as shown on FIG. 8B. Once portable access device 62 is inserted into cavity 110, flipper electrical contacts 102 and 104 become engaged with similarly configured contacts within cavity 110 as is described more clearly below. Also, once portable access device 62 is inserted into cavity 110, controls on the top of armrest 52 may become illuminated (FIG. 8C). In some embodiments, these controls include a “BACK” (optional) button 120 and a “FORWARD” button 122 which may be used when the nature of the presentation and venue permit, for example when the patron is seated in a bus or airplane and views an audio/visual presentation on a screen mounted in the back of the seat in front of the seat in which the patron is seated. In such a case, the patron can be permitted to use “BACK” button 120 and “FORWARD” button 122 to locate portions of the presentation, such as after the presentation has concluded and the patron is given some time to select content for recording or other downloading. These options could not be made available to a patron in certain settings, such as a theater, for example. A “PURCHASE” button 130 is pressed to select recordation of a selected menu item.

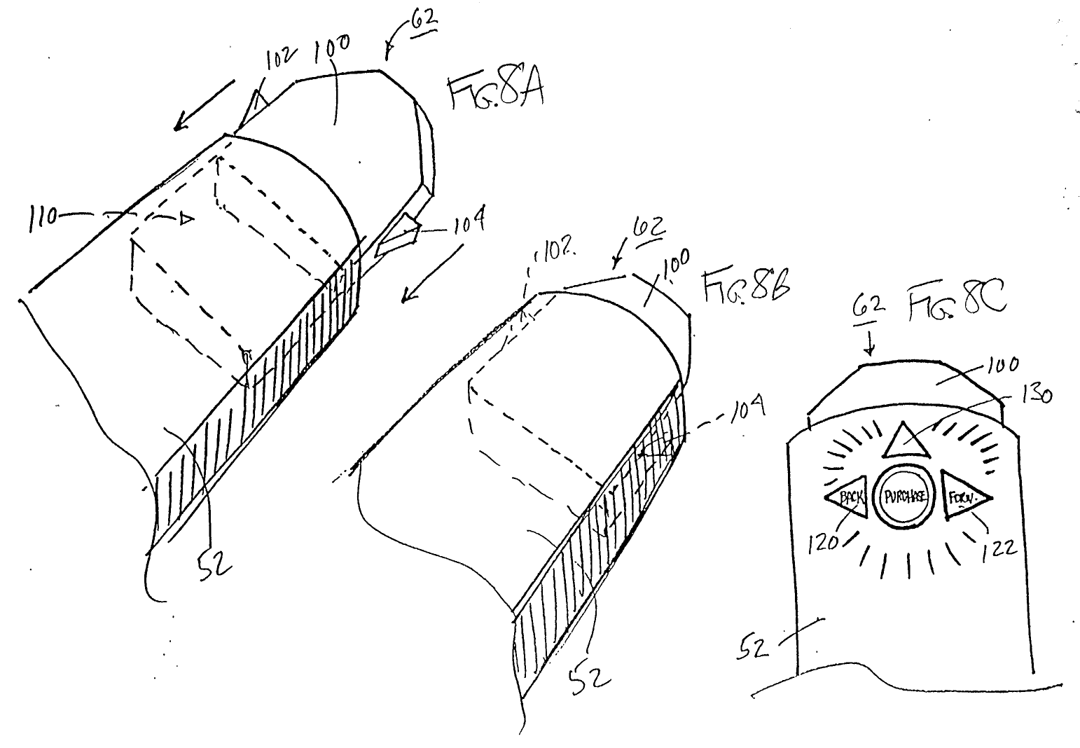

FIG. 9 illustrates how portable access device electrically engages armrest 52 (FIG. 5). It will be understood that flipper electrical contact 104 on portable access device 62 will be compressed into body portion 100 as the portable access device is inserted into cavity 110. When portable access device 62 is fully inserted into cavity 110, flipper electrical contact 104 will be biased outwardly into a portion 140 of cavity 110 and the outer surface 142 of the flipper electrical contact will engage the inner surface of electrical contact 144 disposed in cavity 110. Similarly, the outer surface of flipper electrical contact 102 will engage another electrical contact disposed in cavity 110. Armrest 52 may be configured so that it can be retrofitted to an existing seat 50.

Indicia 160 identifying the patron may be encoded on outer surface 142 of flipper electrical contact 104 so that the patron can be identified when portable access device 62 is inserted into armrest 52 (FIGS. 8A-8C).

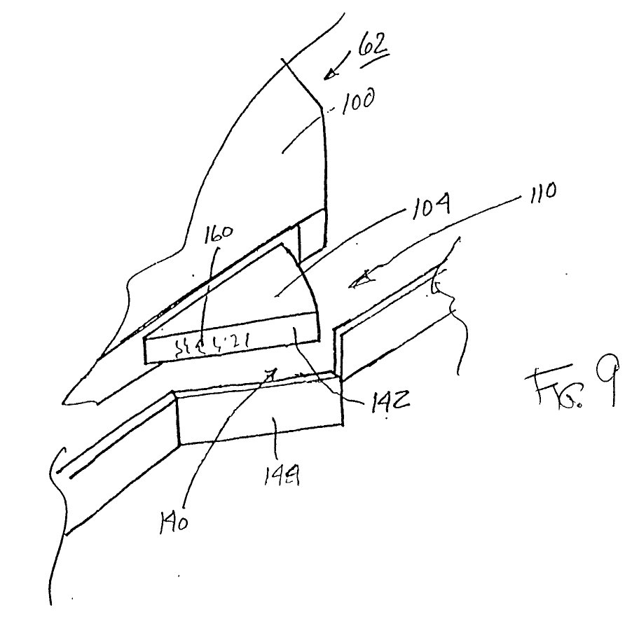

FIGS. 10A and 10B further illustrate the insertion of portable access device 62 into cavity 110 in armrest 52. These figures also illustrate buttons 160 and 162 which can be depressed to force flipper electrical contact 102 and 104 into body portion 100 so that portable access device 62 can be removed from cavity 110.

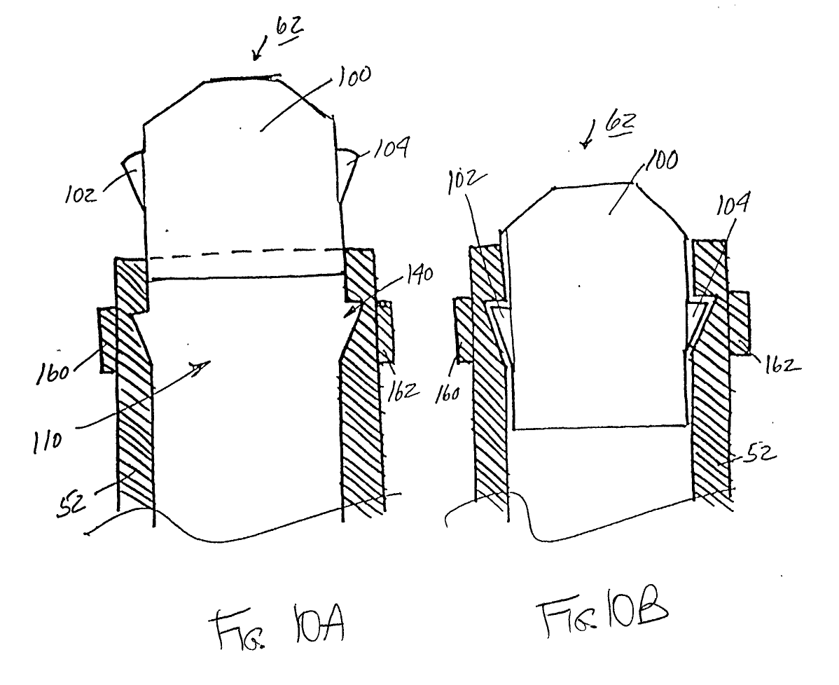

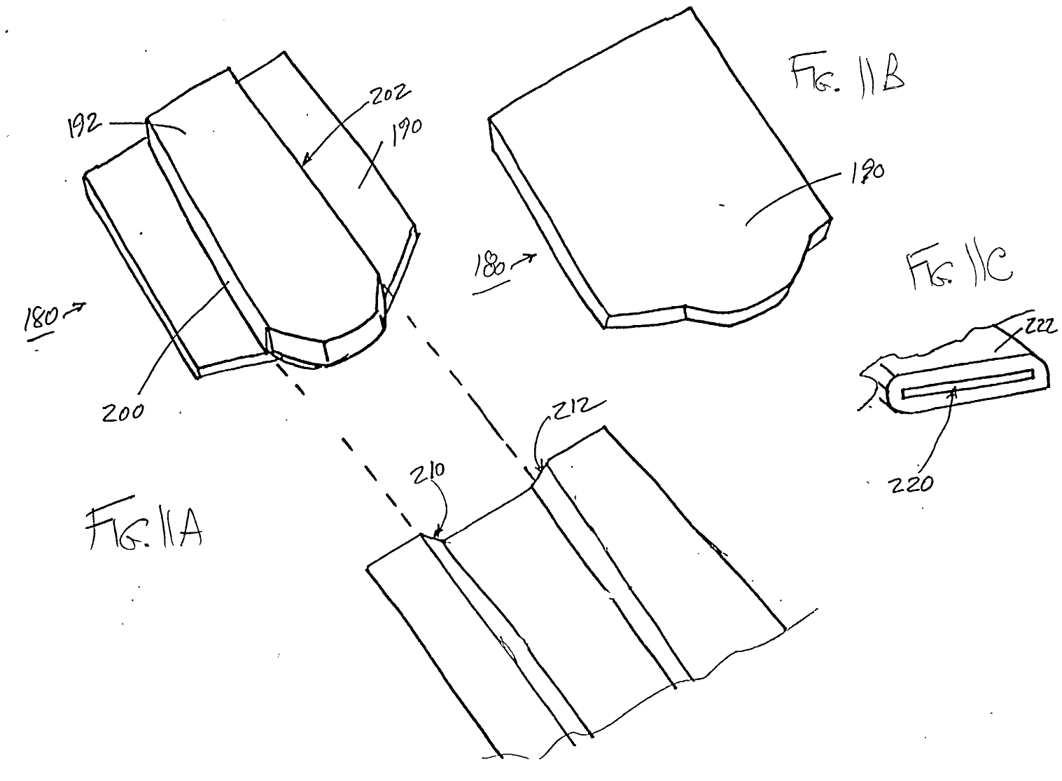

FIGS. 11A, 11B, and 11C illustrate an alternative embodiment of a portable access device, generally indicated by the reference numeral 180. Portable access device 180 has a generally planar upper body portion 190 (FIG. 11B) and an elongated lower body portion 192 (FIG. 11A) extending along the lower surface of the upper body portion along the major axis thereof. Lower body portion 192 includes electrically conductive side members 200 and 202 which are engagable, respectively, with electrically conductive inner surfaces 210 and 212 of a receptacle for receiving portable access device 180. FIG. 11C illustrates a slot 220 formed in the end of an armrest 222 for the insertion therein to of portable access device 180.

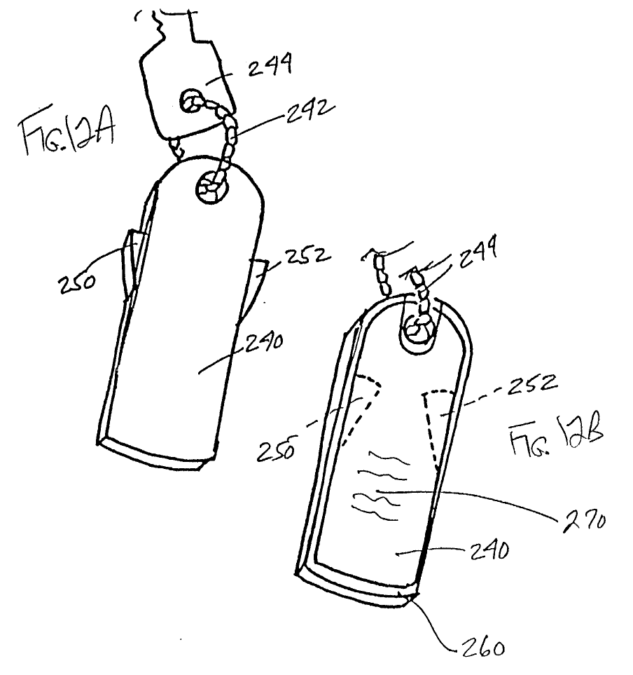

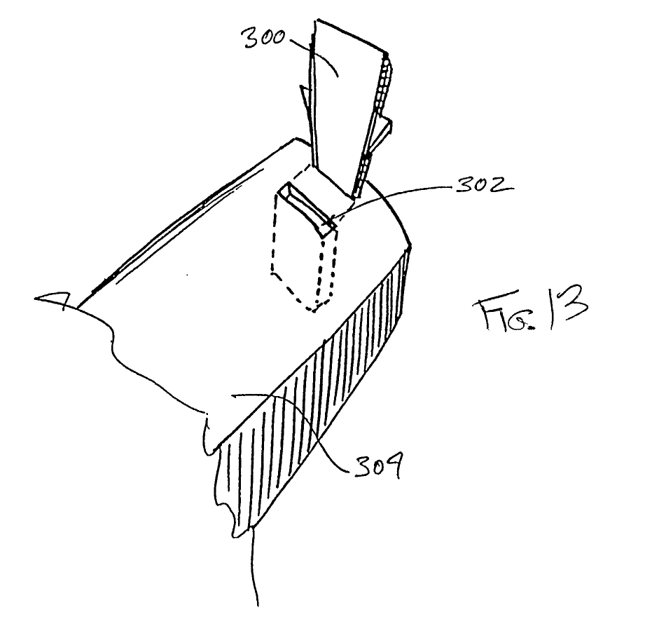

FIGS. 12A and 12B illustrate that a portable access device can be readily portable and lightweight and can travel easily with the patron. Here, a portable access device 240 is attached to a keychain 242, the keychain also having attached thereto a key 244. Portable access device 240 includes two flipper electrical contacts 250 and 252 similar in form and function to flipper electrical contacts 102 and 104 (FIG. 8A). As shown on FIG. 12B, portable access device 240 may be inserted into a protective clear plastic case 260. When portable access device 240 is so inserted in plastic case 260, flipper electrical contacts 250 and 252 are forced into the body portion of the portable access device, Company logos, etc. 270 can be placed on portable access device 240 for marketing and advertising purposes.

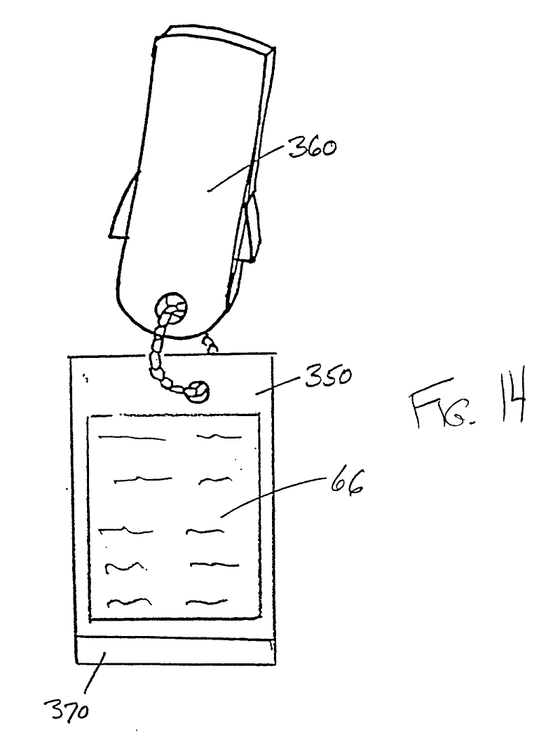

FIG. 13 illustrates and embodiment that may be useful in avoiding a cupholder that may be defined in an armrest. Here, a portable access device 300 is inserted in a vertical slot 400 defined in an armrest, thus avoiding interference with a cupholder (not shown).

FIG. 14 illustrates menu 66 inserted in a clear plastic case 350 which is attached in the manner of a key chain to a portable access device 360. Plastic case 350 includes illuminating means 370 therein so that menu 66 can be easily read in a dark area when portable access device 360 is inserted into an armrest (not shown on FIG. 12).

It is understood that in one aspect of the invention the display of the audio visual presentation is at the pre-determined venue (e.g. a theater) wherein control of the display is by the venue operator (e.g. the theater owner) is outside the control of the patron. The patron nonetheless is able to interface with the presentation through the afore-described access means and with the menu select, retrieve and record content of and or related to the displayed presentation.

In the embodiments of the present invention described above, it will be recognized that individual elements and/or features thereof are not necessarily limited to a particular embodiment but, where applicable, are interchangeable and can be used in any selected embodiment even though such may not be specifically shown.

Terms such as “upper”, “lower”, “inner”, “outer”, “inwardly”, “outwardly”, and the like, when used herein, refer to the positions of the respective elements shown on the accompanying drawing figures and the present invention is not necessarily limited to such positions.

It is to be understood that the terms “patron station” as used hereinbefore and hereinafter throughout the specification and claims contemplate both singular and plural patron operable devices that may or may not necessarily be physically attached to the patron seat.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

What is claimed is:

1. A method for allowing a patron to selectively retrieve content of a presentation, the method comprising:
providing the patron with access to an audio visual presentation system through a patron station, said presentation system displaying said presentation at a pre-determined venue and at a predetermined time not within the patron's control, and said patron station being disposed in said pre-determined venue;
interacting with the patron station to select content related to the presentation; and
recording the selected content.

2. The method of claim 1, comprising providing the patron with a copy of the recorded selected content.

3. The method of claim 1, wherein recording the selected content comprises recording selected content on a recording device operably connectable to the patron station.

4. The method of claim 1, comprising identifying the patron through the patron station.

5. The method of claim 4, comprising automatically charging the identified patron a fee commensurate with the recorded selected content.

6. The method of claim 1, comprising displaying at the patron station a menu showing content available for recording.

7. The method of claim 6, wherein said menu comprises a plurality of pre-determined audio and video content.

8. The method of claim 1, comprising automatically crediting copyright royalties to respective copyright owners for respective selected content.

9. The method of claim 1, comprising linking the patron station with a network connection for said patron content selection.

10. A system for selective retrieval by a patron of audio visual content of a presentation in a predetermined venue, the system comprising:
an audio visual presentation system for presenting the presentation at a predetermined time outside control of the patron;
an interactive patron station at the predetermined venue;
access means for linking the interactive patron station to said presentation at said predetermined venue so that the patron can select desired audio visual content related to said presentation; and
recording means for recording patron selected content.

11. The system of claim 10, wherein the access means comprises the recording means.

12. The system of claim 10, comprising means for linking a network connection with the access means for instructing the network as to the patron's content selection.

13. The system of claim 10, comprising a menu that displays predetermined available content.

14. The system of claim 13, wherein the menu available content comprises content other than content contained within the presentation.

15. The system of claim 10, comprising means for automatically charging the patron a fee commensurate with the selected-recorded content.

16. The system of claim 1, comprising means for automatically crediting copyright royalties to respective copyright owners for respective selected-recorded content.

17. A method for allowing a patron to selectively obtain content relating to an audiovisual presentation, the presentation being presented at a predetermined venue and at a first time period not within the patron's control, the method comprising:
during a second time period linked to the first time period, presenting a plurality of selections representing content items relating to the presentation;
allowing the patron to select one or more of the selections; and
delivering copies of selected content items to the patron.

18. The method of claim 17, wherein the predetermined venue contains a patron station at which the patron is situated during the presentation, and wherein presenting the selections comprises presenting the selections on a display device attached to the patron station.

19. The method of claim 18, wherein delivering copies of the selected portions comprises recording the copies on a medium detachably attached to the patron station.

20. The method of claim 19, comprising allowing the patron to attach the medium to the patron station to receive the recorded copies thereon.

21. The method of claim 17, comprising receiving a payment from the patron for the delivery of the copies of the selected content items.

22. The method of claim 21, wherein receiving the payment comprises receiving a credit card account number from the patron and authorization to charge the credit card.

23. The method of claim 17, wherein the presentation comprises a motion picture presented at a scheduled time at a theater.

24. The method of claim 17, wherein the presentation comprises a motion picture presented on an airplane during a time of travel.

25. The method of claim 17, wherein presenting the plurality of content item selections comprises presenting the selections during presentation of the audiovisual presentation.

26. The method of claim 17, wherein allowing the patron to select selections comprises allowing the patron to select selections only during the second time period.

27. The method of claim 17, wherein presenting the plurality of content item selections during the second time period and allowing the patron to select comprises presenting the selections and allowing selection for a limited time period following presentation of the audiovisual presentation.

28. The method of claim 17, wherein the first time period comprises a scheduled time period for the presentation, and wherein presenting the selections during the second time period comprises linking the second time period to the scheduled time period.

29. The method of claim 17, wherein the first time period comprises the time period during which the presentation is actually presented, and wherein presenting the selections during the second time period comprises linking the second time period to the actual time period for the presentation.

30. The method of claim 17, wherein presenting the selections is performed by a presentation system located at the predetermined venue.

31. The method of claim 17, wherein presenting the selections is performed by a system located remotely from the predetermined venue and accessible at the predetermined venue over a communication network.

32. The method of claim 31, wherein the communication network comprises the Internet.

33. The method of claim 32, wherein the system comprises a web server.

34. The method of claim 31, wherein allowing the patron to select selections comprises communicating the patron's selections to the remotely located system over the communication network.

35. The method of claim 31, comprising the remotely located system identifying the predetermined venue and first time period and presenting the selections based on the identified venue and time period.

36. The method of claim 35, comprising the remotely located system retrieving a schedule of presentations being presented at a plurality of venues and time periods and selecting the schedule for the identified predetermined venue and first time period.

37. The method of claim 17, wherein delivering copies of the selected portions comprises transmitting the copies from a remotely located storage system to a computer designated by the patron.

38. The method of claim 37, comprising transmitting the copies after expiration of the second time period.

39. The method of claim 37, wherein transmitting the copies comprises transmitting the copies attached to an electronic message to the patron's computer.

40. The method of claim 17, wherein presenting selections representing content items relating to the presentation comprises presenting selections of content items incorporated in the presentation.

41. The method of claim 17, wherein presenting selections representing content relating to the presentation comprises presenting selections of content items ancillary to the presentation.

42. The method of claim 41, wherein the content items ancillary to the presentation include one or more content items selected from the group consisting of a director's biography, an actor's biography, location footage, behind-the-scenes footage, alternate cuts, and music videos of songs in the presentation.

43. A system for allowing a patron to selectively obtain content relating to an audiovisual presentation, the presentation being presented at a predetermined venue and at a first time period not within the patron's control, the system comprising:
a selection offering system for presenting a plurality of selections representing content relating to the presentation during a second time period linked to the first time period;
an input device for allowing the patron to select one or more of the selections; and
a delivery system for delivering copies of the selected content items to the patron.
